(19) United States
(12) Patent Application Publication
(10) Pub. No.: US 2005/0186980 A1
(43) Pub. Date: Aug. 25, 2005

(54) Priority-based channel allocation in a satellite communication system

(75) Inventors: Madhavendra Richharia, London (GB); Martin Munday, London (GB); Charlton Baty, London (GB)

Correspondence Address: STERNE, KESSLER, GOLDSTEIN & FOX PLLC, 1100 NEW YORK AVENUE, N.W., WASHINGTON, DC, 20005, US

(73) Assignee: Immarsat Ltd., London (GB)

(21) Appl. No.: 10/514,107

(22) PCT Filed: May 2, 2003
(86) PCT No.: PCT/GB03/01938

(30) Foreign Application Priority Data
May 14, 2002 (GB) 0211031.0

(51) Int. Cl. H04B 7/185

(52) U.S. Cl. 455/509; 455/12.1

(57) ABSTRACT

In a communications system, channels can be assigned during an off-peak period with a lower pre-emption priority than normal channels, and may be pre-empted in favour of normal channels when insufficient channels are available. During a peak period, only normal channels can be assigned. A pool of available channels is maintained above a minimum level by pre-empting lower priority channels. Lower priority channels can be assigned from the pool only when it is above a threshold size. An advantage of this method is that channels can be assigned to noncritical applications during the off-peak period without substantially affecting the availability of channels during the peak period, thus encouraging more efficient use of off-peak channel capacity.

### FIELD OF THE INVENTION

The present invention relates to a method, apparatus and computer program for assigning communication channels in a communications system, and particularly but not exclusively for making use of off-peak channel capacity.

### BACKGROUND

In demand-assigned wireless communication systems, channels are assigned to wireless terminals in response to a channel request, initiated either by the wireless terminal or by a remote terminal setting up a connection with the wireless terminal. As is well known, demand-assigned traffic exhibits a diurnal variation which peaks during business hours, and the communications network must provide enough capacity to service this peak demand with an acceptable quality of service. Outside peak hours, much of this capacity is unused.

Various methods are known for increasing the usage efficiency of the available capacity of a communications system. For example, differential tariffs may be set to encourage users to shift their usage to non-peak hours, or different charging methods may be applied in off-peak hours, such as charging a fixed sum for unlimited off-peak usage.

The functionality of the communications system may be modified to increase the usage efficiency. For example, the document WO 00/17132 discloses a satellite communications system which detects periods of low usage and broadcasts a signal indicating that a discounted tariff is available during those periods; in other words, an off-peak tariff is applied during periods of actual rather than predicted off-peak usage. Once the usage level increases above a threshold, the system signals the end of the discounted tariff period and applies a higher tariff to ongoing calls or new calls after the end of the period. A potential problem with such a system is that it may actually increase peak demand, as the demand from ongoing calls from the discounted period will be added to the normal peak demand. A further problem is that the discounted periods are unpredictable and therefore unsuitable for certain types of traffic.

The document U.S. Pat. No. 5,862,478 discloses a satellite communications. system that temporarily blocks new users during detected periods of high usage. The system broadcasts a signal during a blocking period so that new users do not attempt to set up a call during those periods. However, this approach merely saves some signalling bandwidth without providing a solution to the problem of increasing off-peak usage efficiency.

### STATEMENT OF THE INVENTION

According to one aspect of the present invention, there is provided a period-dependent method of assigning communications channels, wherein in a first predetermined period channels are assigned with a selectable high or low priority and in a second predetermined period channels are assigned with high priority but not low priority. Channels with low priority can be preempted in favour of channels with high priority; in other words, the low priority channel is cleared and its capacity is used to set up a high priority channel. The first period may be a period of predicted low usage and the second period may be a period of predicted high usage. Thus, in a. transition from the first period to the second period, sufficient capacity may be made available for high usage by pre-empting low priority channels.

An advantage of this method is that capacity is made available to non-critical applications during the first period without substantially affecting the availability of capacity during the second period.

It is preferable that the assignment of high priority channels should not be delayed by the need to pre-empt low-priority channels in response to a request for an assignment. Therefore, a number of available channels is maintained for assignment with high priority. When the number of available channels falls below a predetermined threshold, low priority channels are pre-empted and added to the number of available channels. Channels may only be assigned with low priority when the number of available channels is above an upper threshold. This reduces pre-emption probability by avoiding assigning low priority channels when they are likely to be preempted.

Different low usage periods may be defined for different locations and/or service types. Where an allocation table is used to allocate each channel to a channel group, then a low usage period may be defined for that group. The group may correspond to a beam, cell and/or service type.

In an alternative aspect, channels may be available with either high or low priority without any time restriction. However, confining the availability of low priority channels to the first period reduces the probability of pre-emption and the resultant signalling overhead required to pre-empt low priority channels.

According to another aspect of the present invention, there is provided a method of assigning a communications channel to a communications terminal with a low or high priority dependent on predetermined subscription information relating to that communications terminal. This avoids the need for an explicit request for low or high priority at the time of channel assignment and allows the method to be applied to an existing system without changing call set-up protocols.

Alternative aspects of the invention include apparatus and/or a computer program for carrying out the method.

### BRIEF DESCRIPTION OF THE DRAWINGS

Specific embodiments of the present invention will now be described with reference to the accompanying drawings, in which:

FIG. 1 is a schematic diagram of the components of a satellite communications system in an embodiment of the invention;

FIG. 2 is a diagram of the connectivity of the components;

FIG. 3 is a flowchart of the processing of a request for an off-peak channel assignment; and

FIG. 4 is a flowchart of the processing of a request for a normal channel assignment.

### DETAILED DESCRIPTION OF THE EMBODIMENTS

Mobile Satellite Communications System

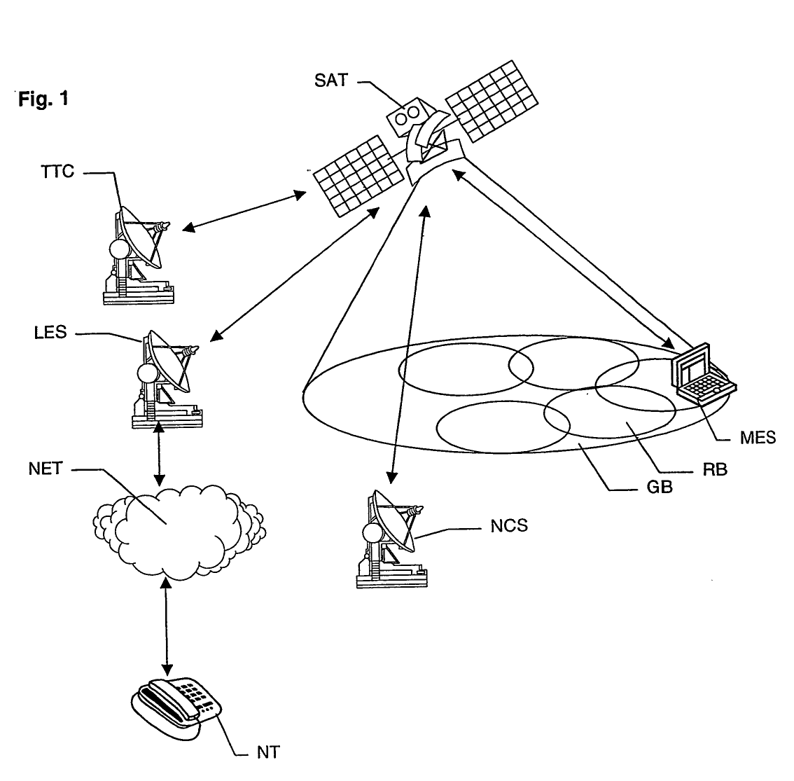

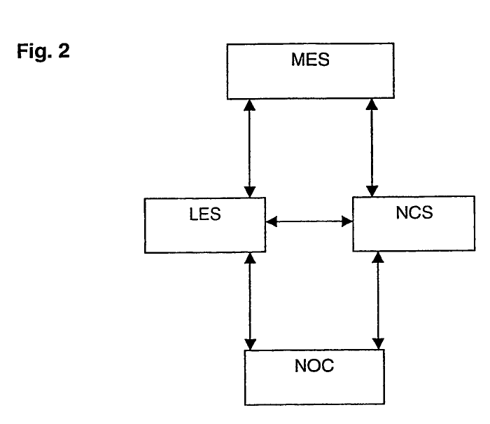

FIGS. 1 and 2 illustrate schematically a geostationary satellite communication system which is a version of the currently existing Inmarsat™ system modified in accordance with an embodiment of the present invention. One or more land earth stations (LES) act as gateways to other communications networks NET for communication with any of a large number of network terminals NT. Each LES is able to communicate with a plurality of mobile earth stations (MES) using radio frequency (RF) channels retransmitted by a geostationary satellite SAT. The feeder link transmitted and received between the LES and the satellite comprises a set of frequency channels at C band, while the user link transmitted between the MESs and the satellite comprises a set of frequency channels at L band. A transmission in the direction from the LES to one or more of the MESs is referred to as a forward link, while a transmission in the direction from one of the MESs to the LESs is referred to as a return link.

A network coordination station (NCS) is able to communicate with both the MESs and the LESs via the satellite and to control the assignment of non-leased channels, as will be described below. The NCS may also function as an LES. A network operations centre (NOC) determines a current frequency plan which it sends to the NCS and LESs, and receives from them channel usage statistics which are taken into account when producing new frequency plans.

The satellite communications system may include multiple satellites SAT, each serving one NCS, one or more LESs, and a large number of MESs.

Satellite

The satellite SAT includes a beam former, receive antenna and transmit antenna (not shown) which generate substantially congruent receive and transmit beam patterns. Each beam pattern consists of a global beam GB, and a plurality of overlapping regional beams RB which are narrower than and fall substantially within the global beam.

The satellite includes a transponder which maps each C-band frequency channel received in the feeder link onto a corresponding L-band frequency channel transmitted in a specified beam in the user link, and maps each L-band frequency channel received in each beam in the user link onto a corresponding frequency channel in the feeder link. The mapping between frequency channels can be altered under the control of a telemetry, tracking and control (TTC) station. The satellite SAT acts as a ‘bent pipe’ and does not demodulate or modify the format of the signals within each frequency channel. The satellite may be one of the Inmarsat-3™ satellites as currently in use and described for example in the article ‘Launch of a New Generation’ by J R Asker, TRANSAT, Issue 36, January 1996, pages 15 to 18, published by Inmarsat.

Channel Allocation

A limited frequency spectrum is available to the satellite communications system at C and L-band. The C-band spectrum may be reused for each satellite SAT, and the L-band spectrum may be reused between non-interfering regional beams RB.

The available L-band spectrum is divided into frequency channels, which may have differing bandwidths, or the same bandwidth. The allocation of the frequency channels to different beams and services is determined by the NOC and communicated to the NCS and the LESs.

In the conventional Inmarsat™ system, some of the frequency channels can be leased on a semi-permanent basis to a specified LES or group of LESs. During the period of the lease, the specified LES assigns its leased frequency channels to MESs without reference to the NCS. Others of the frequency channels are designated as normal, non-leased channels. When setting up a normal channel between one of the LESs and one of the MESs, the NCS participates in the process by indicating the normal channels to be used. Details of known channel allocation schemes for a satellite communications system of this type are described in GB-A-2307826.

In the conventional Inmarsat™ system, a high priority is accorded to specific types of call such as distress calls. This priority is not time-dependent. Where an LES or an NCS receives a request for a high priority call and no traffic channels are available to service that call, the LES or NCS can pre-empt a traffic channel of lower priority that is currently in use, by forcing clearance of the call using that traffic channel and re-assigning the channel to the high priority call.

Off-Peak Allocation and Assignment

In the context of the present application, ‘allocation’ refers to the association of a channel with a particular group having a common purpose, while ‘assignment’ refers to making a channel available for use by a specified communications station. The availability of channels for assignment may depend on their allocation.

In the present embodiment, an off-peak channel type is defined, which can be assigned with low pre-emption priority during an off-peak period to MES/LES pairs which subscribe to an off-peak service. Assigned off-peak channels may be preempted in response to demand for normal channels.

A pool of available off-peak channels is maintained by the NCS so as to provide a buffer between demand for normal channels and availability of off-peak channels. The buffer reduces the probability of pre-emption of off-peak channels and reduces the latency in assigning normal channels.

The off-peak period and pool of available channels may be defined independently for each beam and service type and may be calculated as a function of historic traffic data, such as the carried traffic, busy hour traffic and diurnal variation.

The off-peak period may extend over one or more whole days, such as at a weekend, or over a holiday period. During a working week, typical off-peak periods may extend for 8 to 12 hours for each day. During the off-peak period, there is a low probability of pre-emption of low priority channels.

An example of the handling of off-peak traffic channels will now be described. A channel list file is loaded by the NCS from the NOC, as part of the current frequency plan. At least some of the traffic channels are identified in the channel list as being available as off-peak channels of one of a number of different channel types. The channel types may refer to a specific beam and/or service type. Channels defined as off-peak channels may be assigned to either the off-peak or normal service, while channels not defined as off-peak channels cannot be used for off-peak service.

Associated with each channel type are one or more off-peak time periods, which may vary as a function of day of the week, season or specific days of the year. The off-peak periods are either pre-configured at the NCS or can be loaded independently into the NCS from the NOC. The NCS stores off-peak channel information in an off-peak group table, including the following attributes:
a group type (GT) for each channel, which indicates whether the channel is a normal or off-peak channel;
a channel type identifier (CTI) for each channel, indicating the off-peak channel type;
a lower assignment threshold (LAT), which defines for each off-peak channel type the lower threshold of available channels at or below which the NCS will pre-empt off-peak channels in use;
an upper assignment threshold (UAT), which defines for each off-peak channel type an upper threshold above which the NCS will allow off-peak channels to be assigned;
an allocation blocked flag (ABF), which indicates for each off-peak channel type whether off-peak assignment is permitted.

On loading the channel list file, the NCS counts the number of channels for each off-peak channel type. If the number of available channels for an off-peak channel type is less than the associated LAT, the NCS proceeds to pre-empt off-peak channels of that type in use, if any, until the number of available channels is at the associated LAT or there are no more available off-peak channels of that type, whichever occurs first. The NCS also evaluates the status of each ABF and sets or resets them according to whether the number of available channels is below the associated UAT or not.

The NCS also stores a channel assignment table which records the current assignment status of each channel. For each currently assigned channel, the assignment table records assignment properties such as call type, the LES and MES to which the channel is assigned, and whether the channel is assigned with high or low pre-emption priority.

Off-Peak Request Determination

The NCS stores a subscription table indicating which. LESs support off-peak channels and which MESs have subscribed to an off-peak channel service. In response to a channel request, the NCS determines implicitly that the request is for an off-peak service if all of the following criteria are met:
a) the LES associated with the channel request supports the off-peak service;
b) the MES associated with the channel request subscribes to the off-peak service;
c) the current time falls within an off-peak period of the beam and service type to which the channel request relates.

If any of the criteria is not met, the request is treated as a normal service request. This implicit approach avoids the need to modify existing channel set-up protocols. Alternatively, the channel request may indicate explicitly whether it is a normal or off-peak request and may be treated as an off-peak request if the current time falls within the relevant off-peak period. This alternative avoids the requirement for the MES user to subscribe to the off-peak service in advance.

Different tariffs may be applied to MES users depending on whether a channel is assigned to the corresponding MES under normal or off-peak service. A lower tariff may be applied for off-peak service, to reflect the higher probability of pre-emption. MES users may then take advantage of the lower tariff for non time-critical applications which are tolerant of pre-emption, such as caching, multi-casting, email and web browsing.

The timing of off-peak periods may be determined in advance and communicated to MES users, so that they can configure applications to make use of the off-peak service at pre-set times. Alternatively, the NCS may determine the off-peak period dynamically by monitoring actual channel usage and setting the off-peak period to begin when channel usage falls below a predetermined level and to end when channel usage rises above a predetermined level. In that case, the NCS may broadcast a signal indicating the existence of an off-peak period.

Off-Peak Channel Request

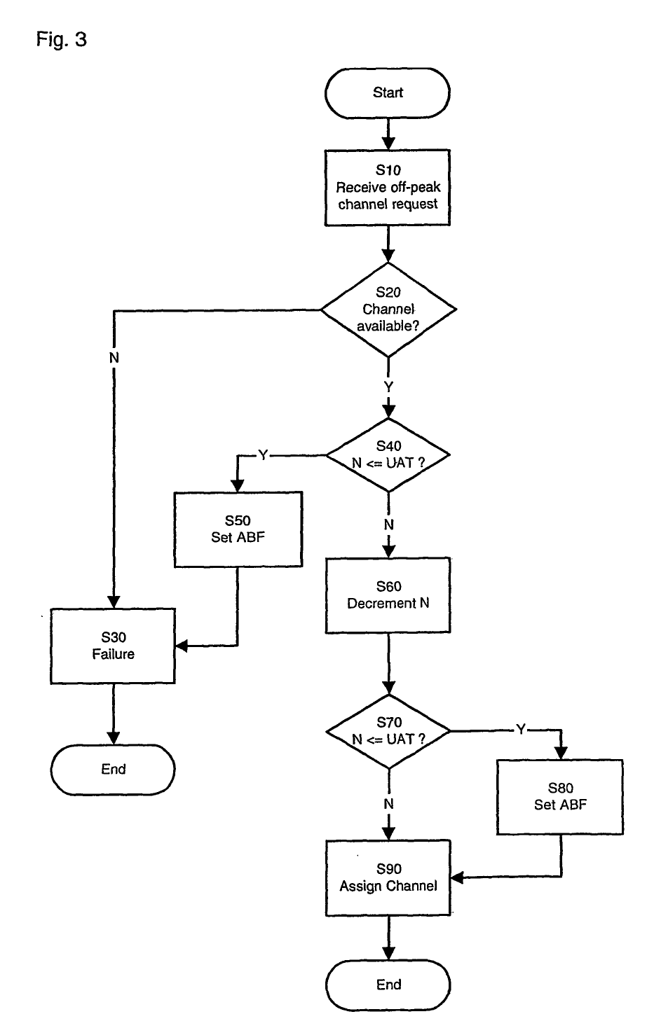

As shown in FIG. 3, when the NCS receives a request (S10) for an off-peak channel assignment, it searches (S20) for an available off-peak channel of the correct channel type (CTI) without the associated ABF set. If no such channel is available, the NCS signals a failed channel set-up attempt (S30).

If a channel of the correct type is available without the ABF being set, the NCS determines the number of available channels N for the corresponding channel type. If the number N is at or below UAT (S40), the NCS sets the ABF (S50) and signals a failed channel set-up attempt (S30).

If the number N is equal to or greater than the UAT for that channel type, the NCS decrements N (S60), sets the ABF (S80) if N is now less than or equal to UAT (S70), and assigns a channel of that channel type (S90).

Normal Channel Request

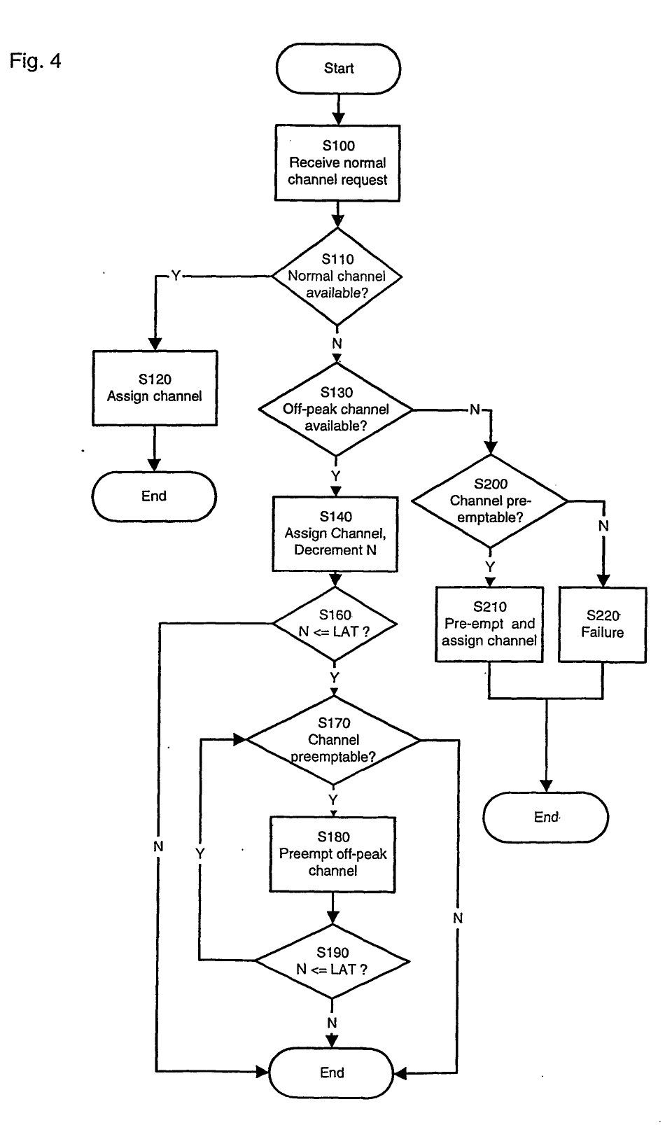

FIG. 4 shows the process performed by the NCS when it receives a request (S100) for a normal (i.e. not an off-peak) channel. The NCS first searches for an available normal channel (S110), and if one is found, assigns that channel (S120) in a known manner. If no normal channels are available, the NCS searches for an available off-peak channel of a type appropriate to the request (S130). If an off-peak channel is available, the NCS assigns that channel and decrements the number of available channels N for that channel type (S140).

If N is now less than or equal to the corresponding LAT (S 160), the NCS begins pre-emption of any off-peak channels currently in use, as follows. The NCS searches for an off-peak channel which is in use with the same channel type as that of the channel just assigned (S170), and sends a pre-emption request (S180) to the LES at which the channel is in use. If there are several candidates for pre-emption, the NCS selects one at random. If the number of available channels is still less than or equal to the associated LAT (S190), then the NCS continues to select and pre-empt off-peak channels until the number of available channels of the current channel type is greater than the LAT or no further channels of that channel type are available to be pre-empted, whichever occurs first. As each channel is pre-empted, the NCS increments the number of available channels N of that channel type.

If no off-peak channels are available for assignment, the NCS searches for an off-peak channel in use (S200), of the appropriate channel type, and pre-empts that channel (S210) for re-assignment to the normal channel request. If no such channel is found, the NCS signals a channel set-up failure (S220).

When releasing an off-peak channel, the NCS increments the number N of available channels of that channel type, and the ABF is reset if N exceeds the UAT for that channel type.

Pre-Emption

Pre-emption support is known in existing Inmarsat™ systems, as well as other wireless systems. An LES receives from the NCS a pre-emption signalling unit (SU) containing the identity of the relevant MES, channel information relating to the channel to be preempted, and a cause code. The LES checks the MES and channel details for a corresponding channel in its channel database and if such a channel is in use, the LES clears the channel by sending a channel clearing signal to the corresponding MES, including the cause code. The LES confirms the channel clearing by sending a channel release signal to the NCS, the channel release signal indicating the channel information of the released channel.

Computer Program

The above embodiment may be carried out by a computer program executed by a computer forming part of the NCS. The computer program may receive the channel list file from the NOC, generate and process the data and data structures described above, and generate and receive the signalling traffic described above between the NCS and the one or more LES's. The computer program may be recorded on a removable or fixed medium or downloaded as a signal.

### Alternative Embodiments

More than two different levels of pre-emption priority may be implemented, and different periods of availability may be defined for each priority level.

Although the above embodiment is described in the context of the Inmarsat™ satellite communications system, it will be apparent that aspects of the present invention are applicable to other satellite communications systems, whether geostationary or non-geostationary, with bent-pipe or processing satellites, and other wireless communications systems, such as terrestrial cellular communications systems. The present invention is not limited to the use of specific frequency bands, such as C and L bands, nor to the use of specific beam types or patterns.

Aspects of the present invention are also applicable to wireline communications systems, where the communications network is able to pre-empt channels in use.

The above embodiments describe the allocation and assignment of channels. The present invention is not limited to any specific channel type or multiplexing scheme. Moreover, the present invention is not limited to channel assignment in response to call set-up requests in circuit-switched networks, but is applicable to channel assignment for other purposes, such as to meet variable bandwidth requirements during a communications session, and/or in packet switched networks.

1. A method of channel allocation in a communications system, comprising:
a. during a first predetermined period, making a channel available for assignment with a low pre-emption priority; and
b. during a second predetermined period different from the first period, making the channel available for assignment with a high pre-emption priority while preventing the channel from being assigned with the low pre-emption priority.

2. The method of claim 1, wherein step a includes making the channel available selectively with the low pre-emption priority or the high pre-emption priority.

3. A method of channel allocation in a communications system, comprising:
a. during a first predetermined period, making any of a set of channels available for assignment selectively with either a high or a low pre-emption priority; and
b. during a second predetermined period, making any of the set of channels available for assignment with the high pre-emption priority but not with the low pre-emption priority.

4. The method of claim 3, including pre-empting one or more of the channels in use with low pre-emption priority and making the pre-empted channels available for assignment with the high pre-emption priority.

5. The method of claim 4, including maintaining at least one of the channels as available for assignment by pre-empting one or more of the channels in use with low pre-emption priority.

6. The method of claim 5, wherein the one or more channels in use with low pre- emption priority are pre-empted when a number of channels available for assignment is at or below a predetermined low threshold.

7. The method of claim 5 or 6, wherein the channels are available for assignment with low pre-emption priority during the first period only when the number of the channels available for assignment is at or above a predetermined high threshold.

8. A method of channel assignment in a communications system, comprising:
a. receiving a request for channel assignment;
b. determining a channel type relating to the request;
c. determining a low or high pre-emption priority relating to the request;
d. determining whether a channel is available corresponding to the channel type and pre-emption priority, and if so,
e. assigning the available channel in response to the channel request; wherein step d includes, if the request has low pre-emption priority, determining whether the request satisfies a predetermined time-dependent criterion.

9. The method of claim 8, wherein said time-dependent criterion is dependent on the channel type.

10. The method of claim 9, wherein the channel type is dependent on a location to which the request relates.

11. The method of any one of claims 8 to 10, wherein step c includes identifying a predefined status of a party to which the request relates, and determining the pre-emption priority according to the predefined status.

12. A method of channel assignment in a satellite communications system, comprising:
a. determining a peak demand period and an off-peak demand period;
b. during the off-peak demand period, selectively assigning channels with either a low pre-emption priority or a high pre-emption priority;
c. during the peak demand period, assigning channels with only the high pre-emption priority; and
d. pre-empting channels assigned with low pre-emption priority so as to make them available for assignment with high pre-emption priority.

13. The method of claim 12, including maintaining a pool of channels available to be assigned with the high pre-emption priority by pre-empting one or more channels assigned with the low priority when the pool falls below a minimum size.

14. The method of claim 13, wherein one or more of the channels are available to be. assigned from the pool with the low pre-emption priority only when the pool is above a threshold size.

15. The method of claim 12, including maintaining a plurality of pools of channels available to be assigned with the high pre-emption priority, each pool corresponding to a respective channel type, by pre-empting one or more channels of a selected one of the channel types when the pool corresponding to that channel type falls below a minimum size.

16. The method of claim 15, wherein one of the channels is available to be assigned with the low pre-emption priority from one of the pools only when that pool is above a threshold size.

17. The method of any one of claims 12 to 16, wherein the satellite communications system includes multiple beams generated by one or more satellites, the beams covering different geographical locations, wherein the channels are each assigned to one of the beams, and the peak and off-peak demand periods vary according to the beams to which the corresponding channels are assigned.

18.-20. (canceled)
